(19) United States
(12) Patent Application Publication
(10) Pub. No.: US 2012/0150555 A1
(43) Pub. Date: Jun. 14, 2012

(54) CLINICAL DECISION SUPPORT

(75) Inventors: Roel Truyen, Turnhout (BE); Alexander Adrianus Martinus Verbeek, Den Bosch (NL)

(73) Assignee: KONINKLIJKE PHILIPS ELECTRONICS N.V., EINDHOVEN (NL)

(21) Appl. No.: 13/392,110

(22) PCT Filed: Aug. 27, 2010
(86) PCT No.: PCT/IB10/53859

§ 371 Date: Feb. 24, 2012

(30) Foreign Application Priority Data
Sep. 4, 2009 (EP) 09169488.5

(51) Int. Cl. G06Q 50/22

(52) U.S. Cl. 705/2

(57) ABSTRACT

A system for clinical decision support comprises subsystems for identifying a plurality of patient information types used in a decision rule of a clinical decision support system; accessing at least one data repository for verifying presence of patient information elements relating to a particular patient; determining which of the patient information types used in the decision rule have corresponding patient information elements relating to the particular patient; and presenting an indication of completeness of the available information relating to the particular patient in view of the information types having corresponding patient information elements or the patient information types lacking corresponding patient information elements. The presenting may be performed by a medical imaging workstation.

### FIELD OF THE INVENTION

The invention relates to clinical decision support.

### BACKGROUND OF THE INVENTION

In current state-of-the-art medicine, health care providers make multiple patient management decisions (such as treatment choices or diagnostic tests) based on a multitude of prior collected patient information including patient medical history, family history, physical examinations, diagnostic tests and response to early treatment. In order to make a decision, health care providers use a lot of prior medical knowledge that comes from implicit sources (like their medical training and experience) but also from more explicit sources, including results of medical research and clinical trials, and global or local clinical practice guidelines. These explicit sources of knowledge evolve rapidly, and there is a clear evolution to improve healthcare by using the latest medical knowledge; this evolution is also known as evidence-based medicine.

Clinical decision support systems are known in the art for supporting clinicians in the process of analyzing clinical information and drawing conclusions from the data, usually based on a set of decision rules. The decision rules may involve the outcome of one or more clinical tests, or other clinical parameters. The outcome of a decision rule may be that another decision rule becomes applicable, so that the patient state moves through a clinical decision tree along a clinical decision pathway. Each decision rule along the clinical decision pathway may need different patient information. Different types of patient information are usually produced by different hospital departments or even in different medical organizations, which makes it difficult to maintain an overview of the available information for a particular patient. Consequently, it may be difficult to know whether sufficient information is available to make a decision.

US 2007/0156453 A1 discloses a medical treatment planning system including a computer having data stored in a memory, said data including a priori information relating to medical conditions, medical treatments, and treatment results. The data further includes executable treatment planning logic including logic that obtains pre-treatment patient data describing the patient's medical condition, logic that analyzes the pre-treatment patient data relative to the a priori information and, based on the analysis, formulates a first treatment plan for treating the patient, and logic that outputs the first treatment plan for evaluation by medical personnel. However, the medical treatment planning system does not provide a way to know whether the available pre-treatment planning data is sufficient to perform the analysis.

### SUMMARY OF THE INVENTION

It would be advantageous to have an improved system for clinical decision support. To better address this concern, a first aspect of the invention provides a system comprising:
an identifying subsystem for identifying a plurality of patient information types used in a decision rule of a clinical decision support system;
an accessing subsystem for accessing at least one data repository for verifying presence of patient information elements relating to a particular patient, the patient information elements corresponding to the patient information types;
a completeness determining subsystem for determining the completeness of the available information relating to the particular patient in view of the information types used in the decision rule and the patient information elements present in the data repository; and
a presenting subsystem for presenting an indication of the completeness of the available information relating to the particular patient.

The indication of completeness shows whether the patient information collected so far is sufficient to apply a decision rule. This is medically relevant, because when the available patient information is sufficiently complete, it is not necessary to collect further patient information, by means of for example medical imaging exams or blood tests; instead, the decision rule may be applied. Using the presentation of the indication of completeness, it is easier to assess whether more information about the patient should be collected. A patient information type may be the result of a particular medical examination or test. Other types of information, such as age, may be used in a rule as well. The patient information elements may contain the actual information of at least one of the types used in the decision rule. For example, a patient information element may contain the actual age of the patient (e.g., ‘64 years old’), or the actual outcome of a medical examination. In this way, it may be verified by the completeness determining subsystem which of the necessary patient information types are available for the patient in the form of corresponding patient information elements, and which information types are not available. This may be used to determine the completeness of the available information.

The indication of completeness may comprise an indication of a degree of completeness. The degree of completeness may indicate, even if the information is not yet fully complete, to what extent the information is complete. The degree of completeness thus may indicate, if the available patient information is not complete, inhowfar the available patient information is complete. Since decisions may be made by a clinician or a group of clinicians in person, the clinician involved may make the decision with some information lacking, but perhaps not with too much information lacking Consequently, the clinician may use the degree of completeness to assess the probability that he can make the decision based on the available information. Similarly, a decision support system may be able to make the decision with some patient information elements lacking. In such a case, the decision support system may be instructed to take the decision, if the presented degree of completeness is deemed sufficient by the clinical staff, for example in view of the burden and/or side effects involved in collecting the missing patient information elements.

The system may comprise a quantifying subsystem for computing a quantification of the completeness of the available information, based on the information types having corresponding patient information elements and the information types lacking corresponding patient information elements. The degree of completeness may comprise the quantification. Such a quantification is an efficient means of presenting the degree of completeness. The quantification can be easily comprehended by the clinical staff and does not add much to the amount of information the clinical staff have to process during the day. A quantification may be visualized by means of a progress bar or by one or more digits. The quantification may comprise a fraction or a percentage.

The system may comprise a plurality of weights representing a relative importance of individual patient information types or patient information elements, wherein the quantifying subsystem is arranged for computing the quantification also based on the plurality of weights. This way, relative importance of patient information elements is taken into account when computing a quantification of a degree of completeness. The presentation of the degree of completeness thus becomes more accurate.

The indication of completeness may comprise an indication of at least one patient information type lacking a corresponding patient information element. This way, the clinical staff can easily see what information type is lacking for the patient. It is easy to determine which additional exams are needed or which information has to be collected in order to complete the patient information necessary to apply the rule of the decision support system.

The system may comprise a decision rule selector for selecting an applicable rule to be used by the identifying subsystem, based on the patient information elements relating to the particular patient. Using the decision rule selector, the system may adapt the rule under consideration based on the contents of the patient information elements available for a particular patient. This way, the system becomes more useful. The indication of the completeness of the available patient information is determined in view of an automatically selected decision rule.

The system may be incorporated in a medical workstation. The system may also be implemented in a distributed computer network. For example, a medical imaging workstation may be provided which receives the degree of completeness, or a quantification thereof, from a computer system, and presents this information to a user by means of, for example, a visualization. Alternatively, the system may be incorporated in a medical image acquisition apparatus.

A method of clinical decision support may comprise:
identifying a plurality of patient information types used in a decision rule of a clinical decision support system;
accessing at least one data repository for verifying presence of patient information elements relating to a particular patient, the patient information elements corresponding to the patient information types;
determining the completeness of the available information relating to the particular patient in view of the information types used in the decision rule and the patient information elements present in the data repository; and
presenting an indication of the completeness of the available information relating to the particular patient.

The method may be implemented as a computer program product comprising instructions for causing a processor system to perform the method.

It will be appreciated by those skilled in the art that two or more of the above-mentioned embodiments, implementations, and/or aspects of the invention may be combined in any way deemed useful. Modifications and variations of the image acquisition apparatus, the workstation, the system, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 is a block diagram of aspects of a clinical decision support system;

FIG. 2 is a block diagram of a method of clinical decision support; and

FIG. 3 shows a schematic overview of determination of completeness of patient information.

### DETAILED DESCRIPTION OF EMBODIMENTS

Health care providers make decisions and take actions using a multitude of patient information, possibly without knowing if all the relevant patient information is available. Examples of such decisions are treatment choices or additional diagnostic tests. The invention disclosed herein is broadly applicable. Although this description focuses on the example of oncology care, the invention is not limited to oncology care. It can be applied to many different medical decision making fields.

Patient management decisions occur frequently in different medical conditions, and decisions may be made by different clinical specialists. As stated earlier, the example of oncology care will be described herein in detail because patient information is very extensive and comes from multiple sources, medical evidence in that field is changing rapidly, and it is very multidisciplinary in nature, which is why it is very difficult for one discipline to have in-depth knowledge of what patient information is necessary to make a decision. However, the invention can easily be applied to other domains of healthcare.

In existing patient management decision making, one relies mainly on the personal judgment of care providers to determine whether all necessary patient information is available, in other words whether the information is complete to a degree which is sufficient to act upon. Paper or electronic pre-structured pro-forma can already incorporate certain a priori knowledge about which information should be available. Incomplete fields in such pro-forma implicitly provide an indication as to whether the information is complete or not, and which information is missing. Paper or electronic pro-forma can be useful when they are filled in by one medical discipline that can keep the overview. When the information has to come from multiple sources and multiple disciplines, it will not reside in one single pro-forma, but instead the information will be scattered throughout the departmental IT systems or the multiple folders in the Electronic Patient Record. Also, a pro-forma is static and has to be explicitly modified with changing medical evidence or guidelines.

In order to improve and assure the quality of patient management decisions, an indication of the completeness of the currently available patient information is proposed. This indication may comprise an indication of (potentially relevant) missing information. An indication of the completeness of information based upon which certain actions of health care providers are taken can be important to prospectively improve the quality of these actions.

To solve this problem, a method may be used which may comprise automatically analyzing the patient information available in the electronic medical record (EMR) or the departmental IT systems. Moreover, the method may comprise determining the completeness of the patient information. It can be determined which information is missing based on algorithms that incorporate a priori knowledge from clinical practice guidelines or pathways, a predefined rule-set determined by the care provider, statistics from prior cases, or another type of computer algorithm.

The method may further comprise providing an indication to a care provider of the completeness of the information. Such an indication may include an indication of which information is missing. The indication may further comprise an indication of how the missing information and/or the completeness were determined.

An indication of the completeness of information and/or an indication of which information is still missing can help care providers to decide collecting the required information before the desired action is taken. This can help to assure actions are taken based on a complete set of information, thus eventually improving the quality of these actions. It can also help to assure completeness of electronic medical records for retrospective use.

Several clinical decision support systems (CDSS) and methods are known in the literature. Such methods aim at providing suggestions for the optimal actions to be taken, given certain patient information be provided as input. According to the invention, these or other CDSS may be configured instead to provide an indication of the completeness of the information required for deciding which action to take.

The invention can be applied to many different kinds of decisions made by care providers. Examples are:
Treatment decisions that rely on information from anamneses, physical exams and/or diagnostic tests
Nursing interventions that rely on information from physical exams and/or bedside monitoring systems
Drug prescriptions by general practitioners that rely on information from patient history, physicals exams and/or laboratory tests.

The invention can be applied to any patient care information systems. Examples are:
Electronic patient/health records.
Hospital information systems.
General practice information systems.
Specialty specific information systems such as Cardiology and/or Oncology information systems.

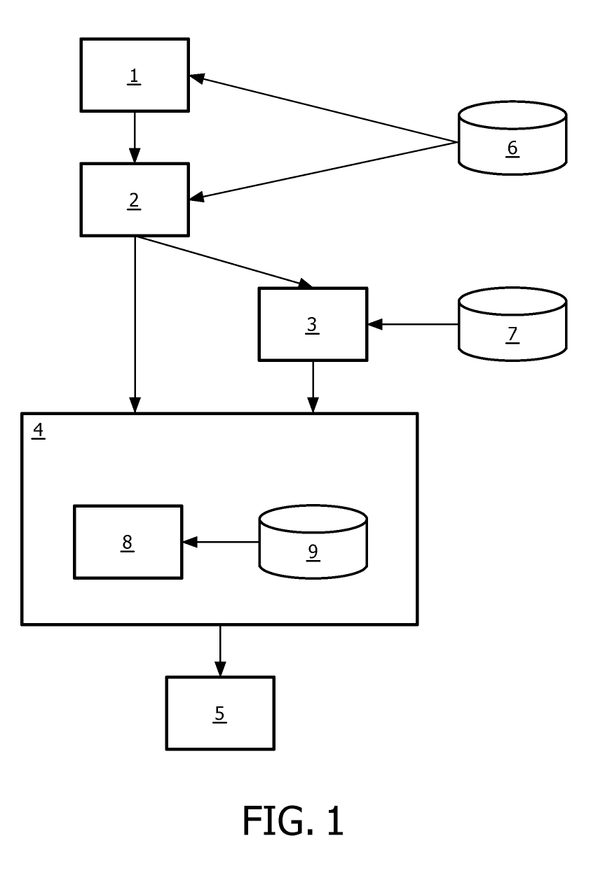

FIG. 1 shows a block diagram of a system which provides an indication of completeness of patient information. The system may be a part of, or an addition to, or partly integrated in, a clinical decision support system. In such a case, the clinical decision support system is extended with an indication of the completeness of available patient information. The system may be implemented in software or by means of dedicated electronic circuitry. The system comprises an identifying subsystem 2 for identifying a plurality of patient information types used in a decision rule of a clinical decision support system. The decision rule may be one of a plurality of decision rules stored in a decision rule storage 6. The plurality of decision rules may be organized as a decision tree. The decision rule may comprise a list or another kind of representation of patient information types which are necessary and/or useful for making the next clinical decision. An information type may comprise a particular kind of medical image of the patient, the age, a particular kind of lab result, or historic clinical information of the patient. The decision rule and the decision support system can be made in such a way that the decision support system can make the decision automatically once the information is available. Alternatively, the decision support system may merely prescribe that the clinical staff should consider the given information types in their decision making In the case where the decision making is automatic, clinical staff may be authorized to override the automatic decision making; moreover, they may be capable of taking a decision before the automatic decision can be made, using less information than needed by the automatic decision rule.

The system may comprise an accessing subsystem 3 for accessing at least one data repository 7. The at least one data repository 7 may store data elements for different patients in different patient records. The data repository 7 may comprise a database with patient information. The at least one data repository 7 may comprise information stored in a distributed way, across a plurality of devices. For example, multiple departments may store their own patient information elements on their own information systems. Similarly, different types of information may be stored on different information systems. For example, laboratory results and image data may be stored on different computer systems. The accessing subsystem 3 may access these information systems for checking the presence of patient information elements for the patient at hand. The accessing subsystem 3 may verify presence of patient information elements in the at least one data repository 7. The accessing subsystem 3 may in particular verify the available patient data elements relating to a particular patient. The patient information elements corresponding to the patient information types of the decision rule are particularly interesting, because these patient information elements can be used when making the decision, and the presence of these patient information elements determines the completeness of the information.

The system may comprise a completeness determining subsystem 4 coupled to the identifying subsystem 2 and the accessing subsystem 3. The completeness determining subsystem 4 may determine the completeness of the available information relating to the particular patient in view of the information types used in the decision rule and the patient information elements present in the data repository. As an example, when patient information elements corresponding to all the patient information types of the decision rule are present for a particular patient, it may be concluded that the available patient information is complete. In another example, if patient information elements are only available for half the number of patient information types in the decision rule, it may be concluded, for example, that the information is not complete or only half complete. More precisely, in this example, if the patient information types contribute equally to the completeness, the completeness is 50%. The completeness determining subsystem may thus give any desired level of detail regarding the completeness of the available patient information.

The system may comprise a presenting subsystem 5 for presenting an indication of the completeness of the available information relating to the particular patient. For example, the presenting subsystem may be coupled to a display, such as a computer monitor, to display an indication of whether the available patient information is complete. The presenting subsystem 5 may also be arranged to generate another indication, for example an audible signal such as a spoken message or an audible alarm.

The system may be arranged to provide the indication of completeness in respect of a plurality of rules. For example, if a decision may be made based on two different sets of patient information types, the system may present indications of completeness in respect of both decision rules.

The completeness determining subsystem 4 may be arranged to determine a degree of completeness. The degree of completeness is not binary complete/not complete. Rather, the degree of completeness is an indication of ‘how complete’ the information is. The degree of completeness may indicate whether the available patient information is far too little to make a decision, almost sufficient for a first guess, sufficient but meager, or sufficient. It can be understood that a decision may often be made in the absence of all useful information. In such a case, the reliability or accuracy of the decision may be lower than when the missing information is also gathered. However, because of other considerations, such as deteriorating patient condition, it may be decided that it is better to make a decision based on the information that is available. The presenting subsystem 5 can help to quickly see if the available information is at least sufficient to make such a decision.

The completeness determining subsystem 4 may comprise a quantifying subsystem 8 for computing a quantification of the degree of completeness of the available information, based on the information types having corresponding patient information elements and the information types lacking corresponding patient information elements. This quantification may be used as the degree of completeness. Quantification can be achieved, for example, by counting the number of available patient information elements, wherein the presenting subsystem can display the number of available patient information elements and the number of patient information types. Alternatively, the quantification can comprise the number of missing patient information elements, i.e., the number of patient information types minus the number of patient information elements. Other quantifications are also possible. For example, the quantification may comprise a fraction or a percentage. Such a fraction or percentage may be computed by dividing the number of available (or missing) patient information elements by the number of patient information types.

The quantifying subsystem 8 may use a plurality of weights 9 representing a relative importance of individual patient information types or patient information elements. These weights may be included in the decision rule stored in the decision rule storage 6, or may alternatively be stored separately as shown at 8. The quantifying subsystem may be arranged for computing the quantification also based on the plurality of weights. For example, a weighted sum is used rather than just counting the number of patient information elements or types.

The indication of completeness may comprise an indication of at least one patient information type lacking a corresponding patient information element. This indication may also be presented by the presenting subsystem 5, for example by displaying the name of the missing patient information type on a display. Such an indication is particularly useful, because it helps the clinical staff to know which information to collect. Moreover, it helps to assess the importance of the missing patient information type(s); for example, if the missing patient information type(s) are deemed not-so-important, they may be omitted, and the decision may be taken.

The system may comprise a decision rule selector 1 for selecting an applicable rule to be used by the identifying subsystem, based on the patient information elements relating to the particular patient. This helps to make the system autonomous. The system automatically may select which decision rule(s) are applicable, based on the current status of the patient which is extracted from the available patient information. For example, if the plurality of decision rules is organized as a decision tree, the decision rule selector may start to automatically apply the rules of the decision tree, based on the available patient information elements. As soon as a decision rule is found for which the information is not complete, this rule may be selected as the applicable decision rule. Alternatively or additionally, the system may select a particular decision rule or decision tree, based on major events recorded in the patient information elements, such as being admitted to hospital, a recent operation, or an important medical diagnosis. For example, a separate rule set may be provided for selecting the applicable decision rule.

A workstation may be provided, the workstation comprising the presenting subsystem 5 for presenting the indication of completeness of the available information relating to the particular patient in view of the information types having corresponding patient information elements or the patient information types lacking corresponding patient information elements. Optionally the workstation may comprise other elements of the system described herein.

The system, in particular the presenting subsystem, may also be incorporated in a medical imaging apparatus. This way, it may be noticed easily whether it is necessary to acquire more image data.

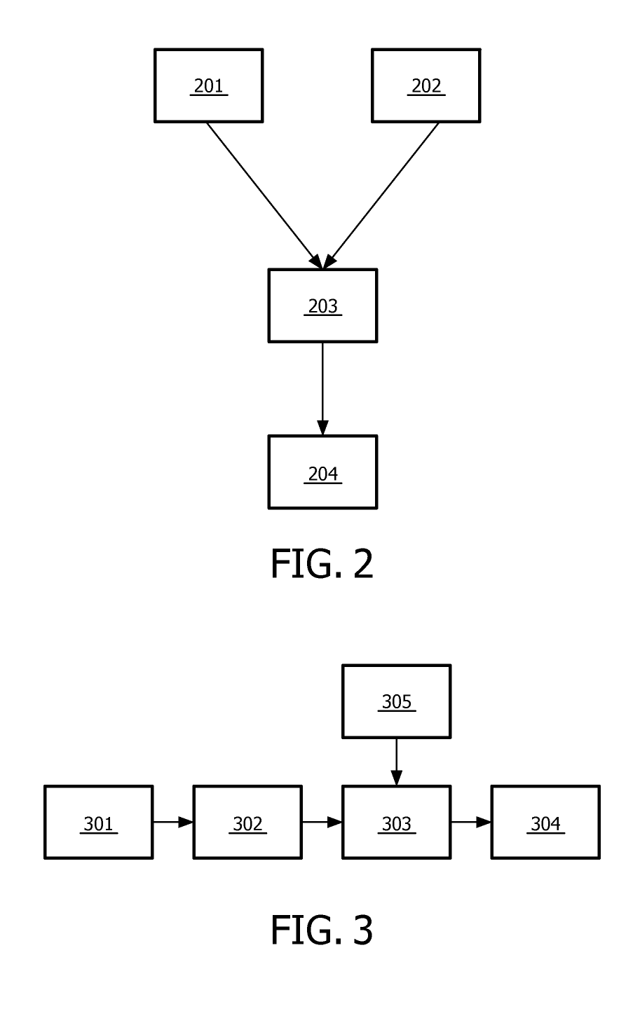

FIG. 2 illustrates a method of clinical decision support. This method may comprise identifying 201 a plurality of patient information types used in a decision rule of a clinical decision support system; accessing 202 at least one data repository for verifying the presence of patient information elements relating to a particular patient, the patient information elements corresponding to the patient information types; determining 203 the completeness of the available information relating to the particular patient in view of the information types used in the decision rule and the patient information elements present in the data repository; and presenting 204 an indication of the completeness of the available information relating to the particular patient. Some method steps may be omitted. Moreover, more method steps may be added, for example based on the functionality of the systems described herein. The order of the method steps may be changed. Some method steps may be performed in parallel or independently of each other, for example step 201 and 202, as illustrated in FIG. 2 by the parallel path. The method may be implemented as a computer program, which may be stored on a computer readable medium.

FIG. 3 shows a schematic overview of the determination of completeness of patient information. As illustrated in the Figure, the system may comprise a patient care information system 301, which makes patient information 302 available via the hospital IT systems in an electronic format. The available patient information 302 may be accessed and processed using known data interoperability protocols (e.g. HL7, see www.hl7.org).

Prior knowledge 305 may be stored in an electronic and computer interpretable form. A simple example of such knowledge representation comprises a rule set. Rules may represent a condition on specific patient information. The condition can relate to patient demographics (age, gender), history (previous cancers, previous surgeries etc), disease type and stage (type of cancer, location, TNM stage), treatments done (surgery, chemotherapy, radiation therapy) etc. Given such conditions, the rule specifies what information is needed to make a further decision on this patient. Examples of such information include availability of specific imaging exams (“PET scan should be available for staging the disease”), status of the reports of these imaging exams (“The ultrasound exam should be reported and finalized”), availability of pathology, lab results, physical results, etc.

A computer algorithm 303 may analyze the available patient information 302 and check which rule condition best applies to the available patient information 302. This best applying rule may be selected. Consequently, the available patient information 302 (including e.g. available imaging exams or reports) may be checked against the information prescribed as “necessary” in the selected rule. This allows the computer algorithm 303 to determine if the available patient information (including e.g. a set of available imaging exams) is sufficient, based on a priori knowledge 305 captured in the rule set.

Subsequently, the user may be provided with an indication 304 of completeness and/or an indication of which patient information (e.g. which imaging exams) are potentially missing. It should be noted that using a rule set is merely an example of an implementation of a completeness indicator. Instead of a rule set, other technical means may be used, for example based on clinical practice guidelines or statistics from prior cases.

Actions of health care providers (e.g. treatment or other patient management decisions made by clinicians) may be based on prior collected patient information (e.g. information collected from anamneses, physical examinations and/or diagnostic tests) and/or a priori knowledge (e.g. from experience, medical research, clinical trials or clinical practice guidelines). In order to improve and assure the quality of such actions it can be useful to provide care providers with an indication of the completeness of the currently available patient information as well as an indication of which information is potentially still missing—for instance with respect to the minimum set of information necessary for a certain action. Herein, an action may comprise making a decision.

A person skilled in the art will appreciate that the techniques described herein may be applied to patient information comprising image data including multi-dimensional image data, e.g. two-dimensional (2-D), three-dimensional (3-D) or four-dimensional (4-D) images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM). The invention may also be applied to non-image data, such as the information present in a medical file, a lab system, or a pathology system.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a floppy disc or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for clinical decision support, comprising:
an identifying subsystem (2) for identifying a plurality of patient information types used in a decision rule of a clinical decision support system;
an accessing subsystem (3) for accessing at least one data repository for verifying the presence of patient information elements relating to a particular patient, the patient information elements corresponding to the patient information types;
a completeness determining subsystem (4) for determining the completeness of the available information relating to the particular patient in view of the information types used in the decision rule and the patient information elements present in the data repository; and
a presenting subsystem (5) for presenting an indication of the completeness of the available information relating to the particular patient.

2. The system according to claim 1, wherein the indication of completeness comprises an indication of a degree of completeness.

3. The system according to claim 2, wherein the completeness determining subsystem (4) comprises a quantifying subsystem (8) for computing a quantification of the degree of completeness of the available information, based on the information types having corresponding patient information elements and the information types lacking corresponding patient information elements;
wherein the degree of completeness comprises the quantification.

4. The system according to claim 3, wherein the quantification comprises a fraction or a percentage.

5. The system according to claim 3, further comprising a plurality of weights (9) representing a relative importance of individual patient information types or patient information elements, wherein the quantifying subsystem (8) is arranged for computing the quantification also based on the plurality of weights.

6. The system according to claim 2, wherein the indication of completeness comprises an indication of at least one patient information type lacking a corresponding patient information element.

7. The system according to claim 1, further comprising a decision rule selector (1) for selecting an applicable rule to be used by the identifying subsystem (2), based on the patient information elements relating to the particular patient.

8. A medical imaging workstation for use in the system according to claim 1, the workstation comprising the presenting subsystem (5) for presenting the indication of completeness of the available information relating to the particular patient in view of the information types having corresponding patient information elements or the patient information types lacking corresponding patient information elements.

9. A medical image acquisition apparatus comprising the system according to claim 1.

10. A method of clinical decision support, comprising:
identifying (201) a plurality of patient information types used in a decision rule of a clinical decision support system;
accessing (202) at least one data repository for verifying the presence of patient information elements relating to a particular patient, the patient information elements corresponding to the patient information types;
determining (203) the completeness of the available information relating to the particular patient in view of the information types used in the decision rule and the patient information elements present in the data repository; and
presenting (204) an indication of the completeness of the available information relating to the particular patient.

11. A computer program product comprising instructions for causing a processor system to perform the method according to claim 10.
